(19) United States
(12) Patent Application Publication
(10) Pub. No.: US 2017/0046487 A1
(43) Pub. Date: Feb. 16, 2017

(54) BIOMEDICAL RESEARCH DATABASE DEVELOPMENT AND USES

(71) Applicant: MEDAWARE SYSTEMS, INC., Broomfield, CO (US)

(72) Inventor: Zung Vu TRAN, Erie, CO (US)

(21) Appl. No.: 15/117,999

(22) PCT Filed: Feb. 13, 2015
(86) PCT No.: PCT/US15/15858

§ 371 Date: Aug. 10, 2016

Related U.S. Application Data
(60) Provisional application No. 61/939,953, filed on Feb. 14, 2014.

(51) Int. Cl. G06F 19/00

(52) U.S. Cl. CPC G06F 19/324; G06F 19/3443; G06F 19/363

(57) ABSTRACT

Provided are methods and systems for extracting, integrating, organizing, navigating and querying a large-scale database constructed from biomedical research studies. The database provides a highly efficient and comprehensive infrastructure for performing systematic and meta-analytic queries across a large number of studies and clinical trials from different areas of biomedical research, as well as systems and methods to build and add to such a database. Active quality control steps ensure fidelity and accuracy of standardized values obtained from a range of biomedical research studies that populate the databased described herein.

### BACKGROUND OF THE INVENTION

The world's biomedical industry generates about 1.5 million research studies each year, published in over 23,000 biomedical journals worldwide. This makes it extremely challenging to remain current in a medical field. For example, a physician would need to read about 19 original articles per day, every day of the year, just to stay current with on-going developments in the field.

Currently, there is simply no practical method to easily and quickly access, filter, and analyze this vast amount of data. In particular, a typical search on NIH PubMed database will return thousands of citations on a given topic. For example, a search of the NIH PubMed database for “breast cancer drug treatment clinical trials” returns over 15,000 citations. Those results may be filtered, such as examining those studies directed to patients based on an age of less than 40 years, which still results in over 50 citations. In the current environment, a clinician would have to read and evaluate those 50 studies in order to obtain useful information as to treatments, outcomes, and the like. Accordingly, there is a need for fast and efficient tools to quickly access and integrate new information to quickly navigate through and analyze study results.

This need is addressed herein by providing users the ability to access the biomedical research from a specially constructed database and, based on the user's search criteria, provide a pooled output of standardized data to quickly, efficiently and reliably provide useful information without any need for the user to review multiple individual citations.

### SUMMARY OF THE INVENTION

Provided herein are databases constructed from biomedical research.

Advantages of the databases provided herein include providing healthcare clinicians, researchers and/or consumers access to: (1) all the world's available medical research; (2) all data extracted, analyzed and presented in a standardized and easily understood format; and (3) access at a button click. In particular, the databases are constructed, modified, accessed, stored, and/or utilized with the assistance of a computer or computer-implemented device. For example, computer-implemented searches and compilation of variables of interest may be performed. The variables of interest are then transformed to a more useful format, including by normalization, weighting and the like to facilitate across-studies comparisons and analysis. The transformed variables of interest also provide the ability to tailor the variables depending on the application of interest, such as deriving parameters useful for diagnosis, treatment, or research. Once the variables are normalized, a computer may be utilized to efficiently populate the database in a readily searchable and analyzable manner, including via a user-implemented search by a different computer with associated query and output display.

Any of the databases provided herein are useful in a variety of applications and settings. For example, a biological sample may be withdrawn from a patient and used with a database described herein, including for diagnosis, treatment, evaluation and/or research. The patient characteristics (age, sex, weight, cognitive assessment) and biological sample characteristics (genetic marker, phenotype, histology, pathology) can be used as part of a query to the database, with attendant output for use in the diagnosis, evaluation, treatment or research. In an aspect, the database is used to diagnose and/or treat a patient. Other applications include use by medical researchers for experimental design and studies, including animal studies, obtaining and/or compiling data of use in a research grant, scientific publication, experimental design, clinical trials or FDA submission.

The databases described herein provide medical professionals, researchers, and consumers the ability to access the entire world's relevant biomedical research. In particular, data from available biomedical research studies is extracted, standardized and incorporated in a database, such as a relational database that is computer-readable. A user may extract data from the database using a specific search request, also referred herein as a search query, and display the results for the specific search request in a user-friendly format that provides rapid and easily understood information, including over a plurality of biomedical research studies. Only data that is fully and precisely applicable is displayed. Because all data have been standardized in the database, there is no need to read through the underlying scientific study and, certainly no need to read through unrelated studies. Instead, based on a user's search criteria, all data is analyzed and presented in an easily readable format, providing instant recognition and understanding of research results across hundreds or thousands and more of studies, providing the most current information for any medical topic. This results in a functional benefit of better patient treatment outcomes and more informed consumer decision making as it is practically impossible for an individual user to otherwise access such pooled information from a large number of underlying biomedical research studies.

Any of the systems and methods provided herein, including specific applications, may be implemented as a cloud-based subscription service or, more generally, in the form of a “Software as a Service” (SaaS). The service may be particularly relevant to individual practitioners, group practices, and institutions. It can also be offered as a pay-per-use model, such as to a general consumer.

Methods provided herein allow for meta-analysis across tens, hundreds, or thousands of the selected studies to show trends, results, and weighted outcomes. This is a significant improvement over the art and provides a number of functional benefits, as discussed herein.

Furthermore, the relational database may be continuously updated to capture any developments in the field of interest, such as by a software implemented search algorithm that continuously crawl through the world's medical and pharmaceutical data repositories to identify and retrieve research studies, keeping the database current and up to date.

An aspect of the invention is that any user of the system, including healthcare clinicians, researchers, and consumers, has the ability to access the entire world's available medical research. Data from the medical studies is extracted, standardized, analzyed and stored into a computer-readable database. Software may continuously crawl through the world's medical and pharmaceutical data repositories to identify and retrieve research studies to update the database. In this manner, a user is saved months of painstaking effort to locate, review, classify, extract, and analyze data from each study.

There is specific application to the methods provided herein for the clinical decision support (CDS) market, which is being driven by a need for greater efficiency and successful patient outcomes, government mandates tied to reimbursements, and reducing malpractice claims by providing current, evidence-based best practices. The methods and systems provided herein are particularly advantageous in providing access to all available research data in a disease area and the tools to synthesize the data in order to better support treatment decisions in daily practice. Furthermore, consumers are completely informed with the same data available to their physicians.

Examples of particularly unique aspects of the methods and systems provided herein include: (1) Generalized, comprehensive search for published and unpublished biomedical studies worldwide; (2) Extraction of variables (data) from hundreds of thousands of these published and unpublished biomedical studies; (3) Construction of a comprehensive database, incorporating hundreds of these extracted variables, creating a taxonomy (description, identification, naming, and classification) for each variable; (4) Development of a user-friendly interface (view, analyze database) to provide full utilization of the database for a range of applications, including patient treatment, research, and consumer support.

The methods and systems provided herein are for searching, extracting, integrating, organizing, navigating, querying, and analyzing a special built, large-scale database constructed from biomedical research studies. It provides a highly efficient and comprehensive infrastructure for performing systematic and meta-analytic queries across a large number of studies and clinical trials from different areas of biomedical research, as well as systems and methods to build and add to such an infrastructure.

One aspect of the invention relates to a user interface that provides a quick but comprehensive way for users to engage the features of the database; graphical and statistical tools are available that allow users to query the database with user specified criteria to pool and analyze data; output or display is in the form of any one or more of plots, graphs, tables, and text.

In an aspect, the invention provides a systematic and thorough process for searching and extracting data to construct a comprehensive database comprised of biomedical research information; the database includes hundreds of these extracted variables, creating a taxonomy (description, identification, naming, and classification) for each such variable.

Specific features of the database include systematic, inclusive and thorough search for the world's biomedical research studies. The medical and life sciences databases include MEDLINE®, EMBASE®, International Pharmaceutical Abstracts (IPA), MICROMEDEX®, CAS® (Chemical Abstracts®), Meyler's Side Effects of Drugs, and ISI's Web of Science® (SciSearch® on Dialog). The Cochrane Database is also searched for reviews that lead to other citations. Other Dialog databases are investigated using the DialIndex® feature. A list of all Dialog databases with descriptions can be found on the web at: library.dialog.com/bluesheets/. The same is done for Ovid Technologies, at http://www.ovid.com/webapp/wcs/stores/servlet/topCategories?storeId=13051&catalogId=13151&langId=-1. As future commercial databases arise, the methods provided herein are readily amenable to include those commercial databases to identify new studies of interest.

In an aspect, the database comprises data extracted from individual research studies, both published and unpublished, and identified in the database as such. In an aspect, the database is populated with an array of variables extracted from studies, where the variables represent features of the studies (Public Information: Citation—full citation appropriate to type of material (book, journal, unpublished report, website) including year of publication; Country of origin; Source of citation—index name, online or print, or other source such as web URL; Demographic Information: age; gender; body weight; race/ethnicity; SES, rural/urban; Experimental Design: randomized parallel group/cross-over; blinding (single/double); Treatment: type; duration; frequency; adherence; Drug Information: name; type, dose (e.g., mg/day); Outcomes: dependent on biomedical area; Other information: subjects' inclusion/exclusion criteria; sample size (attrition); reported side effects; duration of the study; analytic procedures and methods; quantity and quality of supervision; method assessing adherence to the protocols. The variables extraction may be described as falling into three categories: (1) Journal specific global variables; (2) Methods and design variables which describe the overall design and methods to be used within the trial; and (3) the outcomes or results described by treatment group. Clinical practice, subject populations, race, ethnicity, method of treatment, laboratory testing procedures, and criteria for measuring various characteristics change over time and are frequently different among studies. These differences are accounted for by developing a data schema that is specific to an individual disease area. The data schema is dynamic such that over time as treatments and outcomes, measurement methods change the disease specific data schema is configured to evolve to incorporate these changes. In this manner, each individual biomedical research study may be described as having, within the context to the instant invention's database, a unique “fingerprint”.

In an embodiment, provided herein are methods of constructing a database of biomedical research information, such as by searching biomedical research information comprising a plurality of biomedical research studies. As used herein, the term searching is broad and refers to published and unpublished studies, publicly available studies, and studies or information that is generally not publicly accessible but requires additional investigation, as well as government, commercial, and academic activity. From this population of research studies, a biomedical research study of interest is identified and variables of interest and values thereof are extracted from the identified biomedical research study. The process of extracting the variables from a specific research study is a multi-step process which can be managed by custom, proprietary computer-implemented software which standardizes the process. First a research study is imported into the database. A medical librarian logs into the librarian software site to review the study. The Librarian confirms the disease which the research study is investigating, and inputs the abstract by highlighting the correct text and clicking on the variable in the data record for that research study. That study is assigned randomly to two medical research analyst's (MRA's) to code that study. The MRA's log into the data extraction site using their login credentials. The MRA see the research studies that are assigned. The MRA opens a study for data coding. The computer-implemented software guides the MRA through the extraction process. The software displays the study as well as the variables to extract. The MRA highlights an area from the research study and clicks on the variable to be loaded. The software populates the variable with the value selected as well as creates a dynamic link to the text to facilitate review and verification of the selection. Once the MRA is finished coding all values, the study is assigned to a senior MRA for verification. The senior MRA logs in to the administrator site. The senior MRA selects studies that have been completed by both MRA's by viewing the status indicators. The computer-implemented software performs an initial match between the two MRA's that independently coded the study and “approves” those values where the values are an exact match, variable by variable. The computer implemented software also indicates those variables that do not match exactly. The senior MRA then evaluates the values each MRA chose that caused the mismatch. The senior MRA can decide to either send the study back to either MRA for re-coding, select either of the values as the correct value, or select a third value. Once the senior MRA completes the evaluation process and selected all values, the study is uploaded to the final database and is made available for users. This process ensures that the values of the extracted variables of interest are appropriately standardized and accurate. This is an important step in that it allows for comparison across study platforms, including studies that may be structurally very dissimilar. The standardized values of the extracted variables are populated into a computer-readable database, thereby constructing the database of biomedical research.

In an aspect, the extracted variables comprise a plurality of variables for each identified biomedical research study. The variables and values thereof depend in part on the type of biomedical research study. One example of variables of interest for a biomedical research study related to a medical condition of dementia, such as Alzheimer's, is summarized in Table 1. Of course, given that there is no standard reporting format for scientific research studies, and different studies have different protocols, results, and emphasis, many desired variables of interest may not be available within the four corners of the biomedical research study of interest. Optionally, any of the methods provided herein further comprise the step of obtaining a value of a variable of interest from outside the four corners of the biomedical research study of interest. For example, any of the methods provided herein further comprise the step of contacting an author, contributor, or person associated with the biomedical research study of interest to request additional information, including information that will provide a value for one or more variables of interest, or calculation thereof. In an embodiment, this is achieved by a personal person-to-person inquiry. The response to the inquiry may be voluntarily or may involve material compensation so as to increase the likelihood of a successful response. In this manner, a more complete database is constructed in a manner that cannot be achieved by more fully automated methods.

Examples of a plurality of variables of interest comprise at least two of the following: publication information; country of origin; citation source; patient demographic information; medical condition; treatment parameter; outcome parameter; experimental design parameter; subject inclusion and/or exclusion criteria; sample size; side effects; study duration; analytical methodology; supervision parameter; or protocol adherence methodology.

In an aspect, the plurality of variables comprise: at least one variable related to a study characteristic that may affect an outcome parameter; and at least one variable that reflects the outcome parameter. In this aspect, the variables may be directed to studies or research that attempt to treat or ameliorate a disease condition and can be particularly useful in the medical field for treating a medical condition or disease. For example, a study characteristic that may affect an outcome parameter may be a treatment agent such as a pharmaceutical, a drug, a small molecule or other chemical used to treat the disease condition. Other variables may relate to diet, use of supplements/vitamins, exercise and/or the like. Other common variables include treatment regimens including amounts, frequency of treatment, as well as characteristics of the patient population treated (e.g., gender, age, weight, race, and the like).

Examples of a variables that reflect the outcome parameter include, symptom score (e.g, ranging from absent to mild to severe), efficacy (yes/no/partial), outcome itself (cure, partial cure), likelihood of recurrence, side effects (type, severity), mortality and/or survival.

In an embodiment, any the database of biomedical information provided herein is index-searchable by any one or more of the variables of interest. In this manner, a variable of interest related to a disease condition may be searched so that only those studies that pertain to that disease condition are identified. It is then possible to further refine all those identified studies further and into as much detail as desired, such as by patient type, one or more outcome parameters, and treatment type, for example. This can be particularly useful for identifying potential treatment options for a disease condition and can be used to specifically and individually generate a treatment option based on a particular patient's characteristics and medical presentation.

In an aspect, the standardizing step comprises reviewing the values of the extracted variables of interest against a taxonomy of coding procedure and modifying the values in accordance with the taxonomy of coding procedure. Such standardizing facilitates comparisons across any number of different biomedical research studies and is particularly useful for database use and analysis wherein the search query provides pooled data across many different studies that, before the standardization, may not have been readily combinable.

In an embodiment, any of the methods provided herein relate to a modifying the values step that comprises manual review and coding. This is a reflection that with current technology, it is simply not feasible to entirely automate the standardization process via computer language recognition and obtain a sufficiently accurate and comprehensive database. An additional complicating factor relates to the complexities of certain variables and their dependency on contextual language. This is addressed herein by using skilled and trained persons as coders, such as medically-skilled coders including medical students and/or research scientists that review the identified biomedical research study of interest and provide the standardizing step. Of course, as desired, and possible, certain portions of the coding may be automated. Such automation is particularly compatible for those variables that have little, if any, qualitative variation, such as publication information (e.g., year, authors, title, journal, etc.). Other variables that may be more complex or require additional input from outside the content of the research study itself, such as experimental designs (randomization, double blind study, potential conflicts of interest, adequate controls, quality index score), are more suited for manual standardization.

Optionally, to further increase database accuracy, the step of manual review and coding is validated. This validating may be repeating the coding with multiple different coders and allowing the standardizing step to proceed to the populating step only upon agreement between the multiple coders. The validating may be directed to having the same coder repeat the coding of a study at different times to ensure there is not deviation in the coding.

In an aspect, the database further comprises coded variables for all relevant characteristics of each biomedical research study; calculated standardized effect size or an outcome parameter, and original metric outcome. “Coded variables for all relevant characteristics” ensure that every biomedical research study that is standardized and input into the database is uniquely identified. In other words, each study can, and does have a unique fingerprint based on the standardized variables. A “calculated standardized effect size” refers to a numerical magnitude of the response variable to the treatment, in standard deviation units. An “outcome parameter” is a measure of the result of the treatment and can be a qualitative description value related to efficacy, relapse, and associated percentages, or more quantitative in nature. “Original metric outcome” refers to an outcome described by the study itself, in the metric of the instrument used to quantify that outcome.

In an embodiment, the extracting and standardizing further comprises providing a validated data extraction form and inputting the standardized extracted variables of interest to the validated data extraction form. The validated data extraction form is configured for computer-implemented entry into a computer-readable database. For example, after manual entry, the completed data extraction form is made available to a computer implemented reader to populate the database with the extracted and standardized variables of interest. A form is said to be “validated” after an iterative process wherein as the number of studies identified increases, the form is updated and revised to capture all relevant variables and mitigate any discovered coding discrepancies. In this manner, the form may have many variables capable of entry as different studies will have different number and types of variables. A completed validated data extraction form may, accordingly, have blank entries as the form is adapted for use across any number of studies. As described herein, the validating step may comprise standardizing values by independent analysts, followed by a check of the standardized values to pass those standardized values that are identical, or flag for further evaluation by senior analyst those values that do not match. This match/flag step can be automated and implemented via a computer. The senior analyst can then decide whether to send the mismatched values back to one or more analysts for re-coding/re-standardizing, selecting one of the standardized values as correct, or identify a different value as correct, such as by self-coding/self-standardizing.

In an embodiment, any of the methods further comprise repeating the inputting step to identify input differences to minimize coding drift and increase reliability. This repeating may be by a different coder so that the values and completed fields in the data extraction form from the different coders compared and discrepancies identified. Additional training may be provided to the coder in the event an erroneous coding procedure is identified. Similarly, coding procedures may be revised, including revision of the data extraction form in response to identified systemic discrepancies identified by a quality control process.

The methods provided herein are compatible with any number and types of biomedical research information and studies, including future-arising sources of biomedical research information. In an aspect, the searched biomedical research information comprises published and unpublished studies. In an aspect, the searched biomedical research information comprises grey literature. In an aspect, the searched biomedical research information comprises a publicly-accessible database and/or a commercially-accessible database. In an aspect, the searched biomedical research information comprises substantially all peer-reviewed biomedical journals, or at least all the English language journals. In an aspect, the searched biomedical research information further comprises non-English language publications.

In an embodiment, the searched biomedical research information comprises data extracted from individual research studies of at least one of a medical disease treatment and associated outcome. Such information is particularly useful for database applications directed to disease treatment identification, evaluation, and/or implementation.

In an aspect, the biomedical research studies of any of the methods provided herein are directed to treatment of a medical condition associated with the group consisting of: neurological disease; cardiovascular disease; cancer; endocrine or metabolic disease; respiratory disease; infectious disease; pediatric disease; reproductive disease; gastrointestinal disease; musculoskeletal or connective tissue disease; renal or urological disease; hematological disease; psychiatric disease; and dermatological disease.

In an embodiment, any of the methods may use automated searching, such as searching comprising a software-implemented internet search engine that continuously or periodically searches internet sources for available biomedical research studies. In an aspect, the searching is a systematic and thorough search of available biomedical research studies of a medical disease and associated outcome. For example, the searching may also comprise human-directed or manual searching that may be targeted to studies that are otherwise not amenable to automated searching.

Any of the methods herein may further comprise the step of updating the database by periodically repeating the searching to include any newly available biomedical research studies. In this manner, the database is maintained up to date with the most recently available biomedical research studies.

Any of the methods provided herein may further comprise the step of a targeted search outside conventional searching channels. One example of such a targeted search is searching that comprises identifying a specific investigator and requesting the specific investigator to provide an investigator-submitted biomedical research study for inclusion in the database of biomedical information or supply a missing variable of interest for the biomedical research study of interest. In this manner, a much more complete database is obtained compared to a database that simply relies on the searching of available information. For example, it is not uncommon given the large number of variables of interest in play with the instant database for any individual research biomedical research study of interest to not provide a certain variable of interest. In such a case, provided herein is a step where an individual associated with the study will be directly contacted and invited to supply missing information. To increase participation, compensation may be offered that may be non-monetary (e.g., some access to the database) or monetary in nature.

In an embodiment, the method further comprises the step of validating the database of biomedical research information, such as by use of a Scientific Advisory Board (SAB) having expertise in certain disciplines who can conduct search inquiry and confirm certain relevant information based on their expertise is present or absent.

The methods provided herein are useful in any number of applications and for a variety of end-users. In an embodiment, the database of biomedical information is accessed by a medical provider, a medical researcher, or a consumer.

In an aspect, the method database is used to assist in making a clinical decision. For example, the method may further comprise the steps of extracting data from the database of biomedical information by providing a search criteria, thereby generating an output data; and displaying the extracted data to assist with the clinical decision.

The database itself can be made available to an end-user in any number of ways. For example, the database may be accessible as a cloud-based subscription service.

In an aspect, the database may further include a quality index score for a biomedical research study within the database. In this manner, a search criterion may include a quality index score query.

A particularly useful aspect of the invention is that the data extraction step may comprise pooled data from a plurality of biomedical research studies. Conventional literature search activity, in contrast, would require a user to review the underlying studies and incorporate the results or conclusions in the context of the other study. The instant methods, in contrast, avoid this need and the results from the different studies may be automatically pulled from the database and provided to the end-user in any appropriate manner. For example, a graphical representation that includes results from multiple research studies may be automatically displayed in response to an end user search query. For example, the pooled data may comprise biomedical research studies directed to treatment of a medical condition and a search query generates a summary of the research studies, including patient outcome based on a type of treatment.

Databases as provided herein are also well-suited for performing a meta-analysis across a plurality of selected studies.

In an embodiment, the biomedical research information comprises clinical trial studies, non-clinical trial studies, or both.

Also provided herein is a method of using a database of biomedical research information. In an aspect, the method comprises the steps of searching biomedical research information comprising a plurality of biomedical research studies; identifying a biomedical research study of interest; extracting variables of interest and values thereof from the identified biomedical research study; standardizing the values of the extracted variables of interest; populating a computer-readable database with the standardized values of the extracted variables of interest to construct a database of biomedical research information; providing a search criteria input to the database of biomedical research; and obtaining selected information from the database of biomedical research based on the search criteria, wherein the selected information comprises one or more of the standardized values. As discussed, use of such a database is particularly relevant for obtaining information across a plurality of biomedical research studies, also referred generally herein as pooled data. Such pooling is possible by the standardizing that occurs so that data or values of variables of interest can be meaningfully compared across diverse range of studies. Pooled data generated from the databases provided herein avoids the need of an end-user having to individually review research studies and compile the relevant data; an endeavor that is extremely time-consuming, inefficient, and fraught with the potential that relevant studies will be overlooked.

Any of the methods provided herein may further comprise the step of displaying the selected information from the database of biomedical research. The displaying may be an electronic display or may correspond to a more permanent means, such as a hard-copy print out, and/or electronically saved in a computer readable medium.

In an embodiment, the displaying is by an algorithm that transforms the obtained selected information into a user-friendly display. To calculate a standardized effect size using data from the database, and to determine the within group treatment effect, this algorithm calculates the mean (average) difference between baseline and post treatment outcomes. Dividing this difference by the pooled standard deviation of these two means results in the standardized effect size. This calculated value is used in graphical and tabular displays as a measure of treatment effect. (Effect Size=(X̅_{baseline}−X̅_{post treatment})/SD_{pooled}).

One example of such a standardizing and/or displaying step is the MedAware Standardized Cognitive Index (MSCI): Clinical studies, including in the area of dementia/Alzheimer's, use multiple instruments to measure outcomes. The widespread use of multiple instruments/scales quantifying these outcomes decreases the ability to interpret the efficacy of various treatments, particularly across multiple biomedical research studies.

In dementia/Alzheimer's research, the variables of interest and values thereof include at least 82 different treatments (or combination of treatments) using at least 162 different outcome measures. Examples of dementia/Alzheimer's treatments include: Drugs (e.g., donepezil (Aricept®), galantamine (Razadyne®), memantine (Namenda®), rivastigmine (Exelon®), rosiglitazone (Avandia®)); CAM treatments (e.g., apple juice, curcumin, gingko biloba extract (GBE), meditation, vinpocetine (Periwinkle—Vinca minor), yoga. Examples of cognitive outcome measures include: ADAS-cog (Alzheimer's Disease Assessment Scale-Cognitive Subscale), 0-70, BVRT (Benton Visual Retention Test), CDR (Clinical Dementia Rating), MMSE-30 (Mini-Mental State Examination, 30-point scale), 0-30, VTF (Semantic Verbal Fluency Test)

Given that dementia/Alzheimer's research is conducted using multiple treatments and outcomes: (1) how do we determine efficacy of a given treatment (drug/CAM) that uses multiple outcome measures, and (2) how do we pool/combine the outcomes of multiple studies (same drug/CAM)?

With respect to a standardizing step, there is a significant need for a standardized metric that can validly quantify the effect of a given treatment: (1) that measures cognitive changes, (2) that measures cognitive changes in multiple ways (different outcome measures), and (3) from multiple studies that measures cognitive changes in multiple ways (different outcome measures).

To address these needs, a standardizing step that provides an analysis parameter, also referred herein as a MedAware Standardized Cognitive Index (MSCI) is proposed and derived, as in the following example:

TABLE A
Clinical trial, comparing drug (donepezil (Aricept ®)) vs.
placebo using a cognitive scale (ADAS-cog)

| | TREATMENT | | |
|---|---|---|---|
| GROUP | Baseline | Post-treatment | |
| Donepezil 1 | X̅ ± sd | X̅ ± sd | T₁ |
| Placebo 1 | X̅ ± sd | X̅ ± sd | T₂ |
| | | | T₃ |

T₁=T_{ADAS-cog1}=(X̅_{baseline1}−X̅ₚₒₛₜ₋ₜᵣₑₐₜₘₑₙₜ₁)/SD_{pooled1}

T₂=T_{ADAS-cog2}=(X̅_{baseline2}X̅ₚₒₛₜ₋ₜᵣₑₐₜₘₑₙₜ₂)/SD_{pooled2}

T₃=T₁−T₂−

where SD_{pooled1}={square root over (n₁−1)S₁²+(n₂−1)S₂²(n₁+n₂−2))}

SD_{pooled2} is calculated in a similar manner.

Note that Tᵢ is “directional.” This is important because the various scales used (e.g., ADAS-cog, MMSE, and so on) are scaled differently. For instance, ADAS-cog is scaled from 0 to 70, with a higher score indicating greater cognitive dysfunction; while MMSE is scaled from 0 to 30, with a lower score indicating greater cognitive dysfunction.

To adjust for the above, we calculate Tᵢ(−1)=Tᵢ if the scale is scored such that an increase in score always represents improved or better cognitive function, regardless of the scale being used.

Thus, Tᵢ may represent different scales, in standardized units (i.e., there is no metric associated with Tᵢ). Because Tᵢ is standardized as standard deviation units, the range of likely values for Tᵢ is −3.00 to +3.00 (or 3 standard deviation units above/below the mean, which is, in a normal distribution, 99.7% of the data. Thus, an “effect size” as large as +/−3.00 is rare in biomedical research. Most treatment effect sizes are less than +/−1.00.

For each study group (treatment, placebo) a Tᵢ is calculated as above (i.e., T_{ADAS-cog1}). This Tᵢ would represent the effect of donepezil as measured by the ADAS-cog. Another study, also using donepezil as treatment, but measuring its effect using the MMSE scale, would also have a corresponding Tᵢ calculated. Dozens of such Tᵢ could potentially be calculated. Once these Tᵢ are calculated, across multiple studies and multiple scales, we then derive a metric that summarizes, on average, the effect of a treatment (in this case, donepezil). The following estimates the overall effect, weighted by the inverse of the variance, and additional weighting factors q, (q might be a quality index). Thus, we calculate T̅_{.}, also known as the MedAware Standardized Cognitive Index (MSCI) as:

T̅_{.}=Σᵢ^{k}qᵢwᵢTᵢ/Σᵢ^{k}qᵢwᵢ

where wᵢ=1/vᵢ and vᵢ is the variance of means (X̅) denoted in Table A.

Further, to test if T̅_{.}(MSCI) is statistically significant at, p≦0.05, calculate:

Z=|T̅|_{.}/v_{.}^{1/2} where v_{.}=1/Σ₁^{k}1/vᵢ

if Z>1.96, then MSCI is considered statistically significant at the p≦0.05 level.

If a user were to select an output corresponding to a graphical plot, the algorithm may analyze the pooled data and display the data in the form of an x-y graph, with appropriate labels and ranges on the x- and y-axis. Similarly, if the desired output is a table, the algorithm will populate the column and rows and display appropriate headings and labels. In this manner, a user-friendly display is generated wherein meaningful information from the data pulled from the database of biomedical research information is readily and rapidly conveyed to the user. Examples of a user-friendly display include, but are not limited to: a graphical representation; a table; a list; text, and a biomedical protocol. For users desiring to review the underlying biomedical research, the user friendly output information may correspond to a bibliography list of the identified biomedical research studies.

With respect to the searching or querying of a database of the instant invention, the obtaining step may be iterative. In this manner, search results can be further tailored, including based on the number of relevant studies identified in response to a search query. For example, a counter may be provided so that a user can observe the number of unique research studies identified in response to the search query. If the number is overly high, further search criteria or a narrower search query may be employed to reduce the number of identified research studies, thereby assisting in a more meaningful analysis.

In an aspect, the method may further comprise analyzing the obtained information, such as an analyzing step comprising filtering at least a portion of the obtained information. This filtering may be driven by a user, such as by inputting additional search criteria and/or narrowing the previously submitted search criteria. Alternatively, the filtering may be a software algorithm that removes or transforms information as part of the analysis so as to ensure information is provided to a user in a user-friendly manner.

Any of the methods provided herein may further relate to an assessment of the obtained information. For example, this may comprise filtering based on a qualitative or a quantitative assessment of the obtained information. The assessment may be explicitly defined by the user, such as filtering based on study type (e.g., academic or government research versus industry), country of origin, research institution, or any other variable of interest that is associated with the study having standardized variables of interest in the database. Alternatively, an assessment may be generated and associated with the study, such as by a coder standardizing the variables of interest and, as desired, relied on by the user to filter the obtained information.

In an embodiment, the filtering comprises a statistical analysis of the obtained information. For example, such statistical analysis can be useful in meta-analysis applications, such as identifying and evaluating potential treatment options based on a medical disease and one or more patient characteristics. For example, a statistical model is constructed, as specified by the user, to predict (account for) the variance in outcome (standardized effect size), θᵢ, that is composed of a set of study characteristics:

θᵢ=β₀+β₁Xᵢ₁+β₂Xᵢ₂+ . . . +βₚXᵢₚuᵢ (Eq'n 1).

Where β₀ is this model's intercept; Xᵢ₁, . . . , Xᵢₚ are coded study characteristics hypothesized to predict study standardized effect sizes θᵢ; βᵢ, . . . , βₚ are regression coefficients quantifying the association between study characteristics and these standardized effect sizes; and uᵢ is the random effect of study i, i.e., the deviation of study is true effect size from the value predicted by the model (each random effect, uᵢ, is assumed independent with mean 0 and variance σ²_{θ}. Under the fixed effects specification, study characteristics Xᵢ₁, . . . , Xᵢₚ are presumed to account entirely for variations in the true effect sizes. In contrast, the random effects specifications assume that part of the variance in true effects is unexplainable by the model. Thus, this statistical model is a mixed effects linear model with fixed effects β₀, β₁, . . . , βₚ and random effects uᵢ, i=1, . . . , k.

As appropriate, and as selected by a user, other statistical models may be applied to the selected pooled data that comprises the database.

Any of the methods provided herein may relate to obtained data that comprises a pooled set of information from a plurality of biomedical research studies. This is a particularly useful embodiment in that information across many studies may be rapidly disseminated to a user. For example, the pooled set of information may be used in an application selected from the group consisting of: identifying treatment options for a medical condition; evaluating treatment options for a medical condition; selecting a treatment regimen for a medical condition; designing a biomedical research study; diagnosing a disease or medical condition; identifying a medical provider; and a meta-analysis of multiple biomedical research studies.

Any of methods herein relate to a database that is further described as a relational database.

Any of the methods herein may have a standardizing step that comprises a coding procedure for one or more of the variables and codes of Table 1. The standardizing, of course, is at least partially dependent on the application of interest, with different study types and disease conditions capable of having tailored coding procedures to capture aspects unique to those study types and disease conditions. For example, a randomized clinical trial study may have a different coding procedure than a basic biomedical research study from an academic group.

### DESCRIPTION OF THE DRAWINGS

FIG. 1: Process flow overview of the search, extraction, construction and development of a biomedical research database.

FIG. 2: Exemplary sources of information used to search for biomedical research studies of interest.

FIG. 3: Process flow summary for step of extracting of variables of interest from identified biomedical research study of interest.

FIG. 4: Process flow summary for step of standardizing the extracted variables of interest from FIG. 3.

FIG. 5: Summary of one use of a database of the instant invention.

FIG. 6: Example of a user interface for implementing a search query of a database of the instant invention.

FIG. 7: Example of obtained selected information from a database of the instant invention, such as based on a search query of FIG. 6, wherein an algorithm results in display of the obtained information in a user-friendly format.

### DETAILED DESCRIPTION OF THE INVENTION

“Biomedical research information” refers broadly to medical and life sciences studies. Although the database methods and uses thereof may have application in other fields, a focus of the instant technology is on biomedical research, including in the healthcare field. The instant methods are compatible with any type of information relevant to the general field of medicine, medical treatment, medical research and the like.

“Relational database” refers to a database wherein an individual record has multiple parameters and values thereof, and facilitates filtering, comparison and analysis across multiple distinct records. In the context herein, an individual record corresponds to a biomedical research study with attendant variables of interest and values thereof that have been standardized to ensure compatibility and relevancy across different studies. Any individual biomedical research study in the relational database may be uniquely identifiable based on the standardized values associated with the study.

“Standardizing” or “coding” refers to a coding procedure wherein variables of interest are assigned numerical values in accordance with a coding procedure to ensure valid comparisons among different research studies.

“Variables of interest” refers to parameters associated with a research study and that can be used to identify or locate that study based on a search of that variable.

“Values” refers to a measure of the variable of interest. Depending on the variable of interest, the value may be numerical or may be a logical expression, such as yes, no, greater than, less than, present, absent, or the like.

“Populating” or “populated” refers to the organizing, arranging and/or inputting of the standardized values of the variables into a database that can be later accessed, such as by a search query by a user. In this manner, many and up to the entire relevant world's biomedical research studies are computer accessible based on a user's search query.

“Grey literature” refers to studies that are not commercially published, such as in peer-reviewed scientific journals owned by a commercial entity. Instead, grey literature includes studies produced on all levels of government, academics, business, and industry in print and electronic formats. Grey literature may comprise observational data, including from a government agency such as the Centers for Disease Control and Prevention or foreign equivalent thereof.

“Medical provider” refers to licensed physicians or other persons in a position to provide medical advice to a patient. The database provided herein has a number of functional benefits making it useful to a medical provider. The comprehensive, updated and standardization of biomedical research studies allow a medical provider to efficiently, rapidly, and accurately obtain up-to-date diagnosis and treatment option. The structure of the relational database permits targeted and focused searching by any number of variables, including for advice as to hospitals or medical practitioners having the best outcome for a disease treatment. “Medical researcher” refers to a person involved in the study of a medical disease or mechanism associated with a medical disease. “Consumer” refers to an individual desiring to receive biomedical information, and can include an individual desiring information about a specific disease or potential disease conditions based on one or more symptoms.

“Pooling” refers to a combination of variables of interest from more than one research study. The special standardization steps provided herein facilitates such pooling based on a user-initiated query of a database of the instant invention.

“Qualitative assessment” refers to filtering of data based on a user's preference as to a parameter associated with the biomedical research study and tends to be subjective For example, the filtering may exclude data associated with non-peer reviewed publications, publications susceptible to a conflict of interest allegation, or that do not have satisfactory controls. Alternatively, the filtering may be more quantitative in nature, such as based on statistics associated with the data, including statistical significance, population size, a user-generated quality index score, or absence of certain desired variables from the study.

“Quality index score” refers to an indication of at least one characteristic of a biomedical research study. For examples, studies where there is an apparent bias or potential for an unexplained conflict of interest may be associated with a corresponding quality index score that flags the study. The score may be numerical in nature or be associated with a logical expression, yes/no/likely/unlikely, etc. Similarly, experiments that lack adequate controls or validation may be similarly flagged by an appropriate quality index score. Another aspect may relate to funding sources. The quality index score then becomes another tool for use in searching or filtering the database by an end-user

The invention may be further understood by the following non-limiting examples. All references cited herein are hereby incorporated by reference to the extent not inconsistent with the disclosure herewith. Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given.

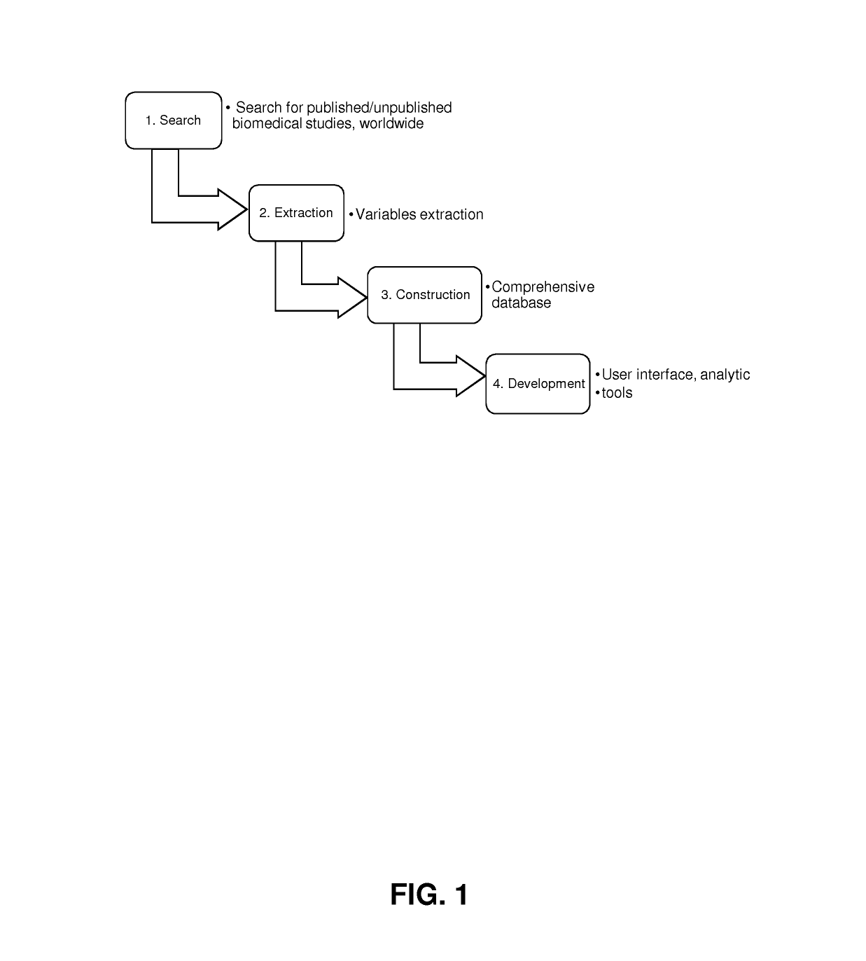

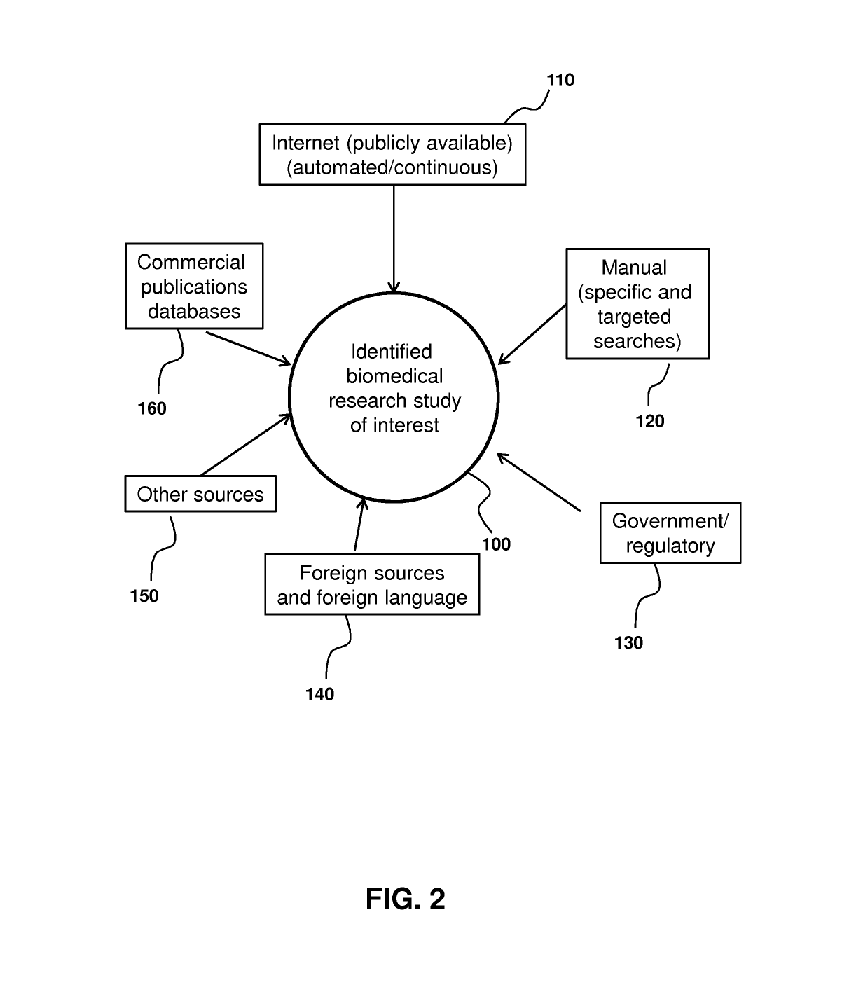

FIG. 1 is a general overview of a method of constructing a database, such as a database of biomedical research information. Key steps include: 1. Search; 2. Extraction; 3. Construction of the database; and 4. Development or use of the database. FIGS. 2-5 further focus on each of these steps.

### Example 1

### Database Construction

Professor Gene Glass first used the term, and advocated an approach to research integration referred to as meta-analysis (Glass 1976) According to Glass, “ . . . it is nothing more than the attitude of data analysis applied to quantitative summaries of individual experiments. By recording the properties of studies and their findings in quantitative terms, the meta-analysis of research invites one who would integrate numerous and diverse findings to apply the full power of statistical methods to the task. Thus, it is not a technique; rather it is a perspective that uses many techniques of measurement and statistical analysis.” ((Glass et al., 1981 (p. 217))

Accordingly, the term, “meta-analysis,” refers to the entire systematic review process that leads to a statistical pooling and analysis of the summary results of individual studies. More recently, “systematic review” has been defined as the process that leads to a “meta-analysis” (statistical analysis), but does not necessarily include it. Thus, in this recent view, a meta-analysis is an end product of a systematic review. For this application, the term meta-analysis is used in the original sense as proposed by Glass. Thus, performing a meta-analysis encompasses both a systematic review as well as the resulting statistical pooling and analysis of the evidence from that subset of available studies meeting predefined (selected) criteria.

Given the proliferation of research published in many fields of science, the meta-analysis of biomedical literature is a vital necessity. Currently, there are about 23,000 biomedical journals worldwide, publishing over 2 million peer-reviewed articles a year (19). It has been estimated that a general practice physician needs to read 19 original articles a day, 365 days a year just to keep their knowledge current.(16) Given this large and ever increasing volume of research to be assimilated, the narrative method of research reviewing—studies chronologically and/or categorically arranged and described is inadequate to summarize and interpret this accumulated research knowledge. In these times, reviews of scientific literature must be rigorous, informative, comprehensive, and explicit.(12).

Searching to Identify Biomedical Research Studies of Interest:

The initial search for research studies begins with the development of designed keywords and subject headings for online searches performed by trained professional medical librarians. Trained professional librarians are helpful to effectively search for relevant literature.(9, 15) The preliminary literature search serves as a basis for estimating the extent of the available indexed and non-indexed (or fugitive) literature. A systematic search of the literature is performed that is consistent, reproducible, and includes all types of literature, indexed and fugitive, in any format. The searches are logged and executed as consistently as possible across the various resources. Conventional searching of the indexed literature is performed against various databases from a number of vendors. The medical and life sciences databases include MEDLINE®, EMBASE®, International Pharmaceutical Abstracts (IPA), MICROMEDEX®, CAS® (Chemical Abstracts®), Meyler's Side Effects of Drugs, and ISI's Web of Science® (SciSearch® on Dialog). The Cochrane Database is searched for reviews that lead to other citations. Other Dialog databases are investigated using the DialIndex® feature. A list of all Dialog databases with descriptions can be found on the web at: http://library.dialog.com/bluesheets/. The same is done for Ovid Technologies, found at http://www.ovid.com/webapp/wcs/stores/servlet/topCategories?storeId=13051&catalogId=13151&langId=-1.

Most current online databases started between 1966 (MEDLINE®), 1975 (PsycINFO®), and 1945, (Web of Science®). Prior to these dates, print indexes are consulted. This includes the antecedents to Index Medicus going back to 1880. For these older materials, Old MEDLINE at the NLM gateway are consulted for 1957 to 1965 literature as well as Web of Science. WorldCat, OCLC's database of over 40 million books are consulted for relevant books—their reference lists are examined. Databases of different types of material are searched, such as Dissertation Abstracts, or the GPO Monthly Catalog.

For international coverage, an appropriate database is EMBASE®. Web-based indexes of fugitive foreign literature are also located. For example, IndMED, a bibliographic database of Indian biomedical research (http://indmed. nic.in/) indexes 75 prominent Indian journals not covered in MEDLINE.

Other Sources of Relevant Literature:

Forward citation searching. Another search strategy is forward citation searching using the Science Citation Index (ISI's Web of Science or SciSearch® on Dialog). This method starts with the relevant study being identified. The study is then tracked forward in time, identifying studies that have cited it. Online searches generally locate less than two-thirds of relevant studies.(7) Database searches alone are incomplete—about 50-80% of all studies are published in journals. The published literature contains select, perhaps biased, information because “statistically significant results” tend to be published more often than non-significant ones.(3, 13)

Cross-Referencing:

Another step in this literature search process is to scan the reference lists of the articles and materials found. These reference lists produce older articles and “grey” or “fugitive” literature not found in indexes. Grey literature is produced on all levels of government, academics, business, and industry in print and electronic formats, not controlled by commercial publishers (Fourteenth International Conference on Grey Literature, Rome, Italy, November 2014,). Recent reports from four systematic reviews of the literature, done at the Canadian British Columbia Office of Health Technology Assessment, found that 30-50% of relevant articles retrieved came from these fugitive sources.(7, 8).

Registers:

Research registers are potential sources of studies. These registers are databases of research studies that are either planned, active, or completed, usually oriented to subject matter or funding source. These registers produce regular reports or listing available to the public. Federal Research in Progress (FEDRIP) provides information about current and ongoing federally funded research listings of over 100,000 research projects annually. ClinicalTrials.gov is a registry and results database of publicly and privately supported clinical studies of human participants conducted around the world. Similar databases also exist in other countries.

Invisible College:

A final search strategy is to locate specific colleagues and investigators in the field and request lists of resources from them. This invisible college of researchers in a targeted biomedical field is compiled and logged in a database. Using these contacts as a data retrieval source is an especially important method for finding relevant results in the non-indexed, fugitive literature.

This procedure of computer online searches, cross checking bibliographies, and hand searches locate most published studies. To avoid introducing a systematic bias (known or unknown) into the database, inclusion criteria are intentionally broad. Because there is no way of deciding whether the set of located studies is representative of the full set of existing studies on the topic, the best protection against an unrepresentative set is to locate as many of the existing studies as possible.(2) Thus, it is unwise to overlook potential sources, if only to affirm the completeness of the list. The point is not to track down every single study only tangentially related to the topic, but to avoid missing useful and informative studies that lie outside one's regular purview. This ensures that habitual channels of information gathering do not bias the selection of studies obtained by the search from the population of all such studies.(2)

Search Validation:

To validate the effectiveness of the search procedures, a Scientific Advisory Board (SAB) composed of experts in the field can be consulted. A listing of identified studies is reviewed by the SAB for completeness. Relevant studies known to members of the SAB, but missed by the search process is added to the working list of studies. A list of active investigators in the many areas of biomedical interest is compiled as per above, and reviewed by the SAB for completeness. In addition to using this list of active investigators as a literature retrieval source, they are contacted for their assistance, adding to the invisible college of researchers in the field.

Publication Language:

Research published in non-English languages is included in the search. Most of the indexed biomedical publications are in the English language. However, an a priori exclusion of foreign language publications is a potential source of bias. The non-English articles are in a number of foreign languages. A translation service (professional translators) is used to translate the written work to facilitate data extraction. An initial review is done based on an English abstract (when available), and the presence of numerical data (e.g., charts and tables). If the article appears to meet inclusion criteria at this step, it is scanned by a qualified scientific reader of that language who fills out a more detailed coding with the help of the research team. Articles deemed “useful” can be professionally translated into English for coding by an English-language coder.

Published Vs. Unpublished Studies:

Another potential source of bias is the existence of a subset of unpublished studies. Sterling et al. (17) presented evidence that published results are not a representative sample of results of all investigations in an area of research. They reviewed studies from 11 major journals and concluded that a publication bias exists that favors publication of studies showing “positive” effects. This bias “distort[s] the results of literature surveys and of meta-analyses.” (p. 108).

In some areas of research,(18) almost all dissertations are subsequently published in indexed sources. A search is performed in the “grey” or “fugitive” literature for dissertations and reports. However, as described above, it is important to actively seek other significant sources of unpublished studies, such as those thrown into the file drawer because the findings were not significant. Such file drawer studies will be considered on a case-by-case basis for inclusion, because, by their very nature, such studies cannot be located by a systematic resource search. One of the characteristics of the scientific methodology is the ability to replicate key methods of any individual study; for meta-analysis, this key area is the literature search (or data collection (and extraction)). Thus, it is important to describe and document in full and appropriate detail the search and retrieval process used.

FIG. 2 is a process flow summarizing various sources of information searched to identify a biomedical research study of interest 100. Certain of the categories of sources explained above may be included in multiple categories. For example, the internet or publicly available sources 110 may also include government/regulatory sources 130, as it is not uncommon for government agencies to make their observations and decisions publicly accessible on the internet (e.g., FDA, CDC, NIH, etc.). Similarly, foreign sources 140, commercial publications 160 and the like may also be accessed via internet-based searching. The manual 120 sources include human-initiated searching of the non-indexed, fugitive or grey literature. It also may include the validation, such as by a SAB discussed above. Other sources 150 is a catch-all category and is a reflection that the searching is comprehensive and broad so as to more completely capture the potential universe of relevant studies.

Extraction of Study Characteristics and Outcomes:

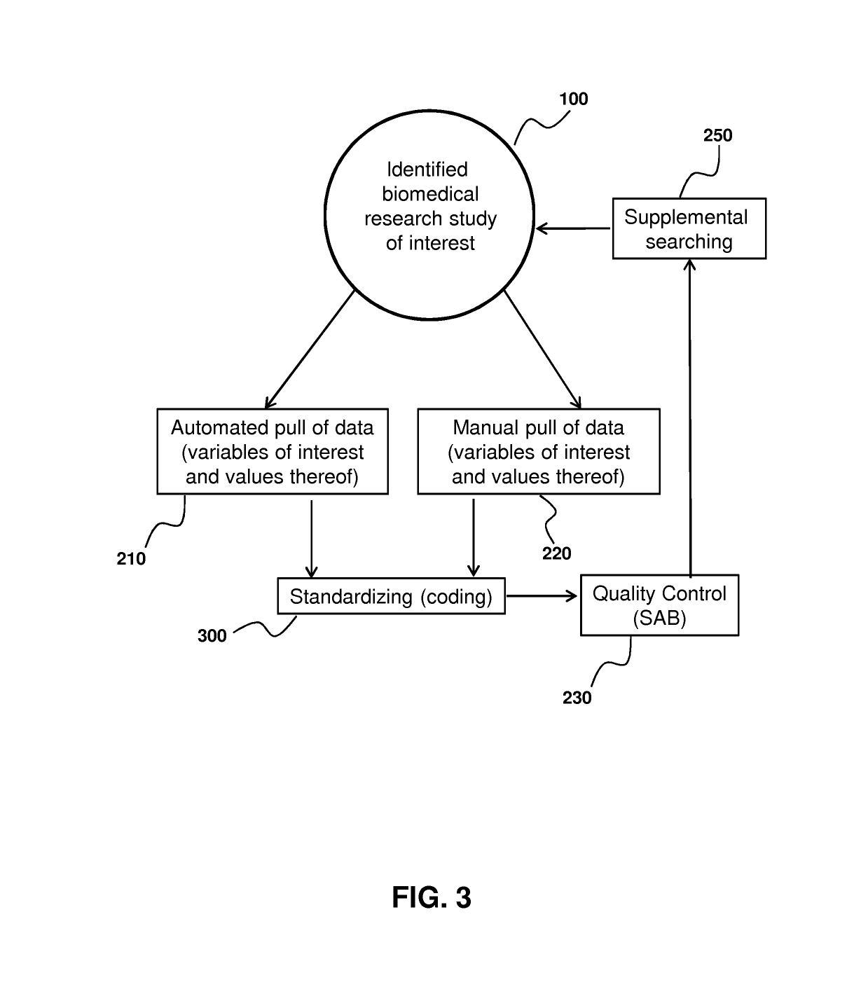

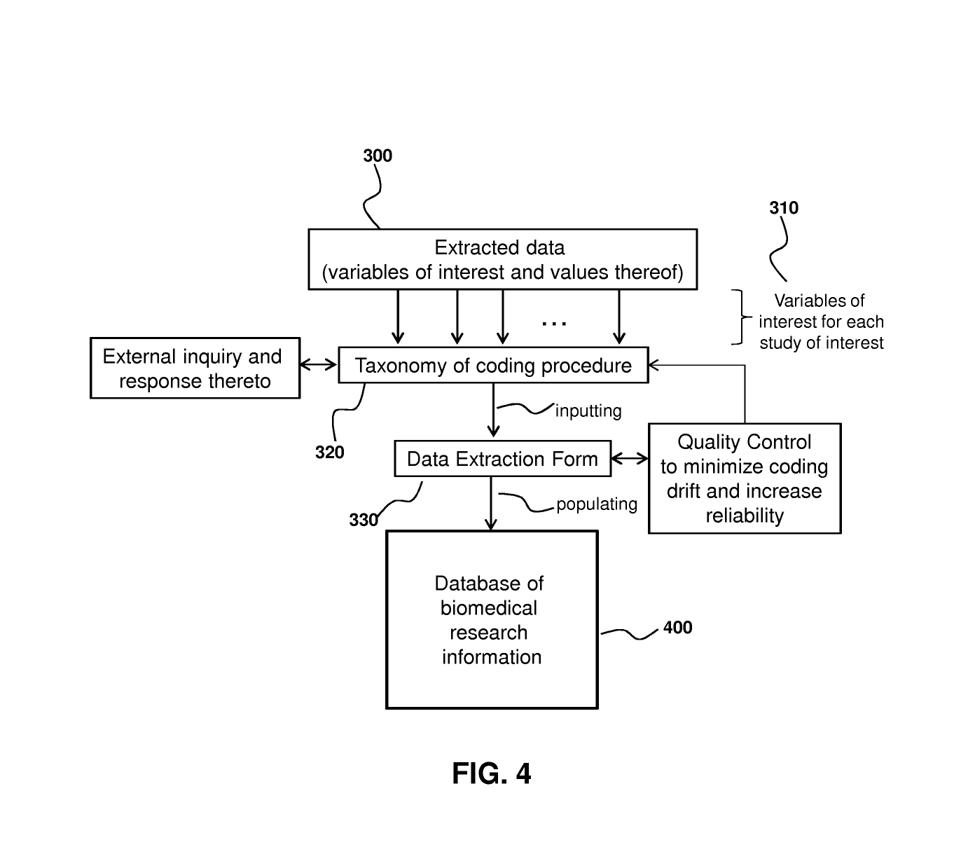

The volume of literature available for any area of biomedical research is very large. Accordingly, the work of search and retrieval, data extraction, coding, and analyses is extensive. Several hundred variables are expected for extraction in the final database. This is necessary because of the diversity of the population of research studies. Careful coding and data extraction lays the groundwork for comprehensive presentation and analyses. FIG. 3 is a general process flow summary for extracting variables of interest from the identified biomedical research study of interest. The extraction may be automated 210, manual 220, or a combination of manual and automated. Automated extraction is more amenable with variables that are readily extracted such as age, gender, dosing frequency, treatment duration and specific drug used. Other variables that are more complicated and subject to interpretation require more effort and tend to more accurately extracted by manual process, with human review, intervention and manipulation. With the relevant data identified (210 220) from the study of interest 100, the variables of interests are ready for the important standardization step 300, as further summarized in FIG. 4. As part of the process of identifying biomedical research study of interest, quality control 230 may be used to assess whether there are missing studies. As indicated, this type of quality control may be experts in the relevant field, as exemplified by Scientific Advisory Board (SAB) 230 and supplemental searching 250 which may correspond to generally to the category “other sources” 150 of FIG. 2.

Data Extraction and Coding.

To ensure full coverage of important variables, the data extraction form and coding procedures (a manual of operational definitions and procedures, also referred herein as a “taxonomy of coding procedure”) are refined based on early results of the search for studies of interest, consultation with the appropriate Scientific Advisory Board, and results of preliminary analyses. Many of the variables reported in the literature are quantified in such a way that they may be easily extracted. Age, gender, dosing, dosing frequency, duration of treatment, and specific drug used are examples of variables that are typically easy to extract. Other variables require more elaborate coding rules.

Design of Data Extraction Form.

Important steps in acquiring data and preparing for presentation and statistical analysis are: (1) data extraction/coding, (2) data entry, and (3) data reduction. Data extraction/coding requires reading a study and extracting the relevant information on a computerized representation of the form. A poorly designed form can significantly impede data entry and greatly increase the number of data entry errors. The initial drafting of these data extraction form usually proceeds as follows: (1) approximately five to ten “typical” studies are carefully reviewed to determine what variables are being reported, and how they are being measured; (2) a preliminary draft of the form is produced; (3) this draft form is tested by coding the set of typical studies on hand; and (4) the form is revised to reflect the additions and modifications to the variables and codes. The data extraction form undergoes changes and additions as studies are gathered, and are finalized when a large set of studies meeting inclusion criteria are acquired. Thus, the initial part of building this database is devoted to developing a reliable and valid extraction form and operationally defining coding procedures. Accordingly, any of the methods provided herein may further comprise one or more of these steps for making the data extraction form. A data extraction form that has an undergone these updates and revisions may be referred herein as a “validated data extraction form”.

Examples of characteristics and outcomes extracted (finalized with input from the Scientific Advisory Board), also referred to generally herein as “extracted variables of interest and values thereof”, include: Public Information: Citation—full citation appropriate to type of material (book, journal, unpublished report, website) including year of publication; Country of origin; Source of citation—index name, online or print, or other source such as web URL; Demographic Information: age; gender; body weight; race/ethnicity; SES, rural/urban; Experimental Design: randomized parallel group/cross-over; blinding (single/double); Treatment: type; duration; frequency; adherence; Drug Information: name; type, dose (e.g., mg/day); Outcomes: dependent on biomedical area; Other information: subjects' inclusion/exclusion criteria; sample size (attrition); reported side effects; duration of the study; analytic procedures and methods; quantity and quality of supervision; method assessing adherence to the protocols. Based on the type of variable of interest, the value thereof may be quantitative in nature (e.g., a number selected over a continuous range) or may be based on a logical expression (or a numerical value provided thereto that may be discontinuous: NO=0, YES=1).

The variables included in the final data extraction form fall into two general categories: (1) study characteristics that may relate to the outcomes, and (2) the outcomes themselves. Clinical practice, subject populations, race, ethnicity, method of treatment, laboratory testing procedures, and criteria for measuring various characteristics change over time and are frequently different among studies. These differences are accounted for by developing appropriate coding procedures, thereby providing variables described herein as “standardized”.

Data Extraction Bias.

Inter-extractor bias refers to whether two or more data extractors (also referred herein as “coders”) agree on the interpretation of information being extracted and coded from the studies. Thus, starting with two research associates, they are trained and systematically monitored to do the extraction. To minimize inter-extractor error, and maximize objectivity of the extraction procedures, a formal coding manual (with operational definitions) is developed and used. This manual is also referred herein generally as a “taxonomy of coding procedure.” Also, the two extractors code the same studies (e.g., a dozen or so), compare their codings (using objective measures of inter-extractor reliability, e.g., kappa coefficients for nominal data and intraclass correlation coefficients for ordinal or continuous data), and resolve differences where there are disagreements with the coding. The coding manual is then revised to avoid future ambiguity. To further improve variable standardization, extractors may begin independent coding only after a specified quality metric is obtained. For example, extractors may begin independent coding only after reliability ratings of 0.70 or greater are consistently obtained across all coding categories on at least 3 blocks of 12 or more studies. Some of the variables coded call for some subjective judgment on the part of the extractors. To increase reliability and decrease intra-extractor bias, each extractor will code several studies and then recode the same studies a week or so later to determine whether there are any differences between the codes on the two different occasions. Additionally, at random intervals, extractors will, without their knowledge, be given the same set of studies to code to re-ascertain acceptable inter-extractor reliability. These checks of both intra- and inter-extractor reliability are performed throughout the extraction process to guard against coding drift. Differences are analyzed by area managers, and resolved to consensus to minimize future discrepancies. This aspect is generally described as a “quality control” process.

Studies with Missing Covariate Data.

Studies do not always report data on variables that may have an effect on outcomes, such as sex, body weight, and age. As a result, the use of multivariable statistical methods to examine the effects of these variables on changes in outcome can be severely hampered. Current meta-analytic methodology employ either simple or model-based procedures for handling missing data.(86) Simple strategies include (1) complete case analysis, (2) single value imputation, or (3) regression imputation. Complete case analysis consists of using only those studies that include all variables being examined at the time. This can result in a large number of studies excluded from analysis. Complete case analysis assumes that the included cases are representative of the original sample of studies. Single value imputation consists of filling in some judicious value for the missing information. For example, many investigators use the mean value of that variable calculated from cases (studies) that reported the variable. However, use of this method artificially deflates the variability of the variable. The third simple method for dealing with missing data is regression imputation.(1) This method uses regression techniques to estimate missing values, replacing missing values with the conditional mean. Use of this method assumes that missing values can be predicted from a linear regression model estimated from complete cases. However, the acceptability of this method depends on the reasons data are missing.

More recent model-based methods include, (1) maximum likelihood and (2) multiple imputation. The maximum likelihood method, by Little and Rubin,(11) was designed to deal with observations missing for reasons related to the observed variables in the data. The problem with this method, however, is determining the reasons for missing observations. The multiple imputation method, by Rubin,(14) consists of imputing more than one value for each missing value and obtaining a range of possible values for each missing observation. Both these methods have not been used extensively in meta-analytic research. No easy solution currently exists for handling missing data. We consider data imputation methods to be the creation of “artificial data”, and maximum likelihood techniques rely on an understanding of the reasons that data are missing, which is difficult to determine, the complete case approach is preferred.

However, prior to applying any statistical missing data methodology, the process provided herein may include the step of contacting the original author(s) in an attempt to increase the number of complete cases by obtaining values for missing variables. Information from authors is requested by one or more of the following means: postal mail, phone, fax, e-mail. A log is kept of (1) authors contacted, (2) methods used to contact authors, (3) time to respond, (4) variables requested, and (5) response rate. This is likely the best (most valid) approach to take. In some previous studies, the success in retrieving missing data was approximately 25% (35% of studies meeting inclusion criteria had missing data). In this manner, the database may include variables of interest that are not otherwise publicly accessible, but instead requires personal contact with an author and that is explicitly outside the four corners of the otherwise accessible biomedical research study of interest.

In another project, a more elaborate approach to retrieving missing data from investigators was taken. The purpose of the study was to examine the feasibility of acquiring individual patient data (IPD) for a meta-analysis. Kelley and Tran (10) were able to obtain data from 29 (38.2%) of the 76 eligible studies. Prior to sending out the request for IPD, a cover letter and IPD request sheet were developed, reviewed, and revised. Requests were sent, via postal mail (a copy of the cover letter and an IPD data acquisition form), to the corresponding authors of the 76 studies. A follow-up request, approximately five weeks later, was sent to all authors who did not respond to our initial request. If the corresponding author referred us to one of the co-authors, contact was made with that author in an attempt to retrieve IPD. The first request contained no deadline date for the receipt of IPD. However, the second request included a deadline date of approximately four weeks from the date of mailing for the receipt of IPD. This deadline was extended for those authors who contacted us to request additional time to provide us with IPD. All authors who supplied IPD were mailed a check for $40.00 (US) to help cover incurred costs.

The amount of missing data to be requested from any given investigator is usually much less than for the above cited IPD study (e.g., it may only be a “standard deviation” that is missing). Following this process should provide a much better response rate than in previous meta-analyses projects. However, in the event that this approach does not generate sufficient additions to the database to correct the problems of the complete case approach, data are analyzed using the alternative approaches described above and results presented in terms of their consistency across multiple solutions to the missing covariate problem. A quality index score may be generated based on such statistical solutions so that, as desired, variables having a statistical significance below a user-defined threshold may be excluded.

FIG. 4 summarizes one embodiment of the standardizing procedure. Briefly, each of the variables of interest 300 identified and pulled from each of the biomedical research studies of interest, such as summarized in FIGS. 2-3, are examined. The variables of interest for each study of interest 310 are represented as a plurality of any number of arrows. This reflects that each variable of interest for each research study is reviewed against a taxonomy of coding procedure 320 and input into data extraction form 330, which is used to populate a database of biomedical research information 400.

### REFERENCES FROM EXAMPLE 1

1. Buck S F. A method of estimation of missing values in multivariate data suitable for use with an electronic computer. J Roy Statist Soc Ser B 1960; 22:302-306.
2. Cooper H M. Research synthesis and meta-analysis: a step-by-step-approach (4th ed.) Los Angeles: Sage Publications; 2009.
3. Egger M, Smith G D. Bias in location and selection of studies. BMJ 1998; 316(7124):61-6.
4. Glass G V. Primary, secondary, and meta-analysis of research. Educational Researcher 1976; 5(10):3-8.
5. Glass G V, McGaw B, Smith M L. Meta-analysis in social research. Beverly Hills: Sage 1981.
6. Jackson G B. Methods for reviewing and integrating research in the social sciences. National Science Foundation 1978:PB283-747.
7. Helmer D, Wright M, Kazanjian A. Shooting from the hip or target practice?: A comparison of conventional and fugitive search results. In: MLA/CHLA/ABSC 2000; 2000; Vancouver, B.C., Canada; 2000.
8. Helmer D, Savoie I, Green C J, Kazanjian A. How do various fugitive literature searching methods impact the comprehensiveness of the literature uncovered for systematic reviews? In: New frontiers in Grey literature: Fourth International Conference on Grey Literature, 4-5 Oct. 1999: GL'99 proceedings.; 1999; Kellogg Conference Center, Washington (D.C.), USA: Amsterdam, The Netherlands: GreyNet, Grey Literature Network Service; 1999.
9. Higgins J P T, Green S (editors). Cochrane Handbook for Systematic Reviews of Interventions Version 5.1.0 [updated March 2011]. The Cochrane Collaboration, 2011
10. Kelley G A, Kelley K S, Tran Z V. Exercise and lumbar spine bone mineral density in postmenopausal women: a meta-analysis of individual patient data. J Gerontol A Biol Sci Med Sci 2002; 57(9):M599-604.
11. Little R J A, Rubin D B. Statistical analysis with missing data (2nd ed.). New York: John Wiley & Sons; 2002.
12. Mangano D T. Effects of acadesine on myocardial infarction, stroke, and death following surgery: A meta-analysis of the 5 international randomized trials. The Multicenter Study of Perioperative Ischemia (McSPI) Research Group. JAMA 1997; 277(4):325-32.
13. Pate R R, Pratt M, Blair S N, et al. Physical activity and public health. A recommendation from the Centers for Disease Control and Prevention and the American College of Sports Medicine. JAMA 1995; 273(5):402-7.
14. Schell C L, Rathe R J. Meta-analysis: a tool for medical and scientific discoveries. Bull Med Libr Assoc 1992; 80(3):219-22.
15. Rubin D B. Multiple imputation after 18+ years. J Am Stat Assn 1996(91):473-489.
16. Sackett D L, Haynes R B. Evidence-based medicine notebook. EBM 1995; 1:5-6.
17. Sterling T D, Rosenbaum W L, Weinkam J J. Publication decisions revisited: the effect of the outcome of statistical tests on the decision to publish and vice versa. Am Stat 1995; 49:108-112.
18. Tran Z V, Weltman A, Glass G V, Mood D P. The effects of exercise on blood lipids and lipoproteins: a meta-analysis of studies. Med Sci Sports Exerc 1983; 15(5):393-402.
19. Williams C J. The pitfalls of narrative reviews in clinical medicine. Ann Oncol 1998; 9(6):601-5.

### Example 2

### Using a Database

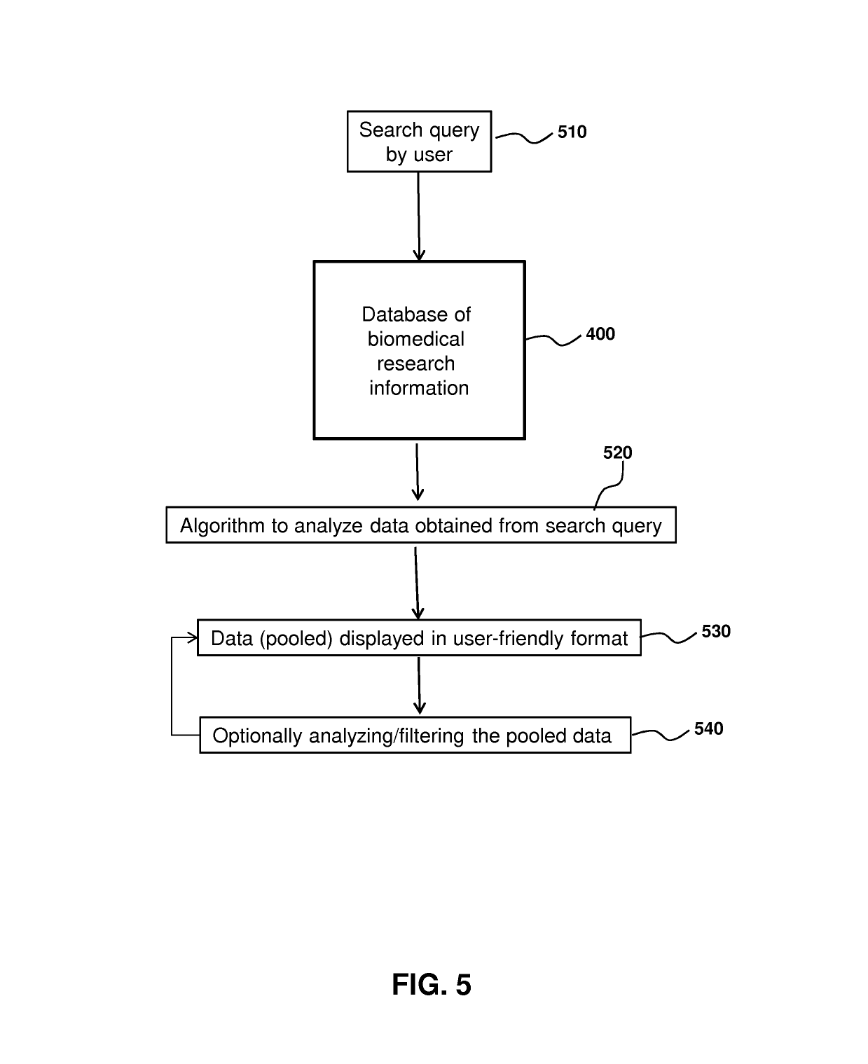

Due to the unique database construction wherein every relevant medical study is identified and parameters associated with the study standardized, to generate a database, multiple studies may be efficiently identified based on a user's interest and, in particular, the user's search query or input search terms. For example, FIG. 5 is an example of using a search input or query 510 for treatment options of a medical condition. The search query 510 of database 400 results in, depending in part on the search query, pooled data displayed in a user-friendly format 530, such as an algorithm 520 that within the context of the search query appropriately displays the pooled data appropriately. For an intermediate type search query, the display may be as simple as a counter that outputs the number of research study hits from the search query. As desired, a user may review the pooled data and further analyze or filter the pooled data, as illustrated in step 540, resulting in an updated display. The term display is used broadly to include any form of output that is of practical use to a user (e.g., on a display, stored on or in a computer-readable medium, hard-copy).

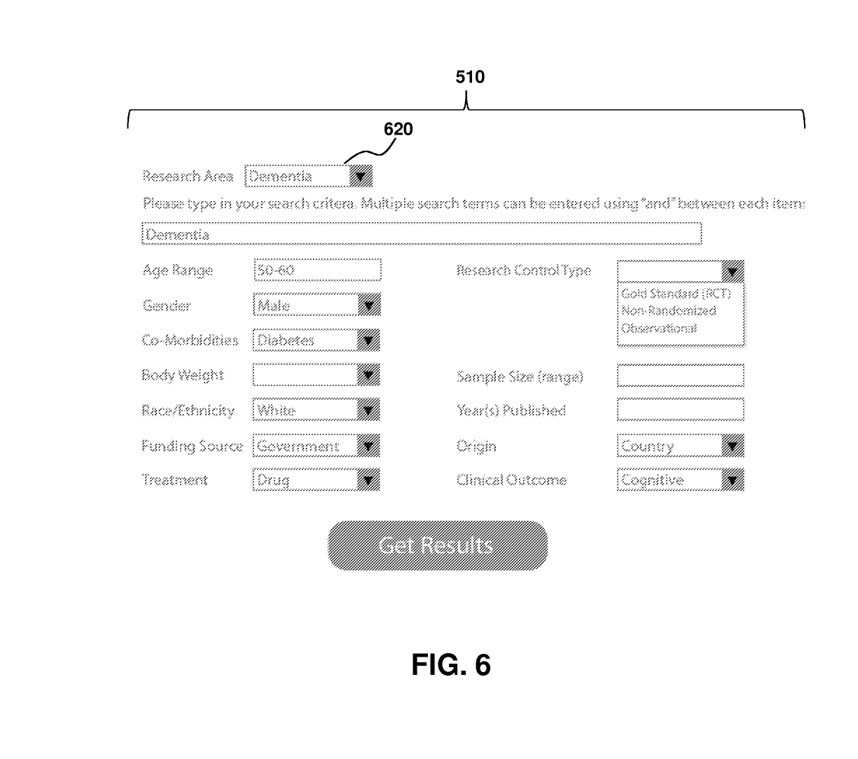

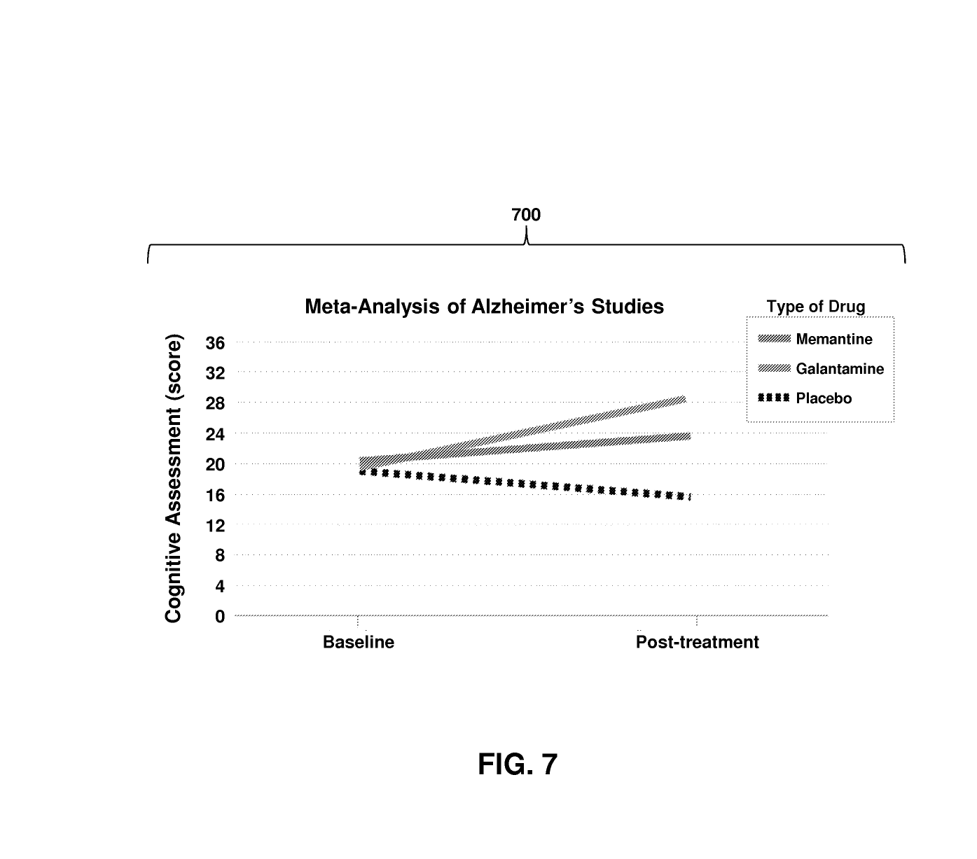

The search query 510 may be implemented in the form of a graphical user interface (GUI), as illustrated in FIG. 6. The GUI may have any number and types of fields, dependent in part on the user-selected research area 620. In this example the medical condition is dementia, and various fields are entered to describe the patient, funding source, treatment, research control type, clinical outcome and others. The fields may change depending on entries in the fields. For example, if treatment were exercise, additional fields may appear related to exercise type (e.g., mental, physical), frequency and/or intensity. An important illustration of the GUI is that for any field displayed, there is a corresponding standardized variable of interest available in the database. Based on this search inquiry, an algorithm identifies this search query as directed to medial treatment of dementia by drugs with a clinical outcome corresponding to cognitive and may provide an appropriate user-friendly display 700 upon initiation of the search query of the database. The output is schematically illustrated in FIG. 7 as a graphical plot of the effect of different drug treatments on cognitive assessment. The algorithm specifically selects an appropriate legend to distinguish different drug types and conveniently plots the clinical outcome on an x-y plot. This is one example of a user-friendly display in that it rapidly conveys information that one drug appears to provide a better cognitive outcome than another, and that both are better than no drug treatment. These results may be from a plurality of different biomedical research studies, but due to the standardization and database construction provided herein, are readily pooled and displayed.

The exemplified output illustrates the advantages of the instant invention in many different ways. For example, the output provides treatment information for a very specific patient (see FIG. 6 search query) without having to review the underlying research studies, which could correspond to a very large number of studies in any number of foreign languages and across a range of sources. In other words, there may simply be no practical way for a physician to access all the underlying information that goes into the output 700. To the extent that scientific review papers may provide such information, any such reviews are by their nature at risk of being out of date by the time they publish and have a substantial lag in timely availability. These drawbacks are avoided in the instant invention wherein the database can be continuously updated to include all the most recent studies. FIGS. 6-7 provide but one example of how the database provided herein can be used; the database can be similarly used for any other disease condition, medical treatment or other biomedical parameter with a matched algorithm to provide a user-relevant output.

### STATEMENTS REGARDING INCORPORATION BY REFERENCE AND VARIATIONS

All references cited throughout this application, for example patent documents, including U.S. Pat. App. 61/939,953 filed Feb. 14, 2014 from which the instant application claims priority, including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, and method steps set forth in the present description. As will be obvious to one of skill in the art, methods and devices useful for the present methods can include a large number of optional composition and processing elements and steps.

When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a number range, a quantity range, or any other range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

TABLE 1
An exemplary taxonomy of coding procedure (Alzheimer's Example)

| Variable of Interest | Coding and Modifying Procedure |
|---|---|
| Publication Information | |
| Journal Name | 1. [use journal listing] |
| | 2. |
| | X. xxx. |
| Journal Availability | 0. Available at no cost |
| | 1. Available at journal website ($) |
| Author[s] | |
| Surname/Initials | |
| Year of Publication | yyyy |
| Volume/Issue/Pages | |
| Study Design | |
| Study Design1 | 1. Narrative review |
| Type of study | 2. Meta/systematic review |
| | 3. Cross-sectional study |
| | 4. Retrospective |
| | 5. Pre/post, no control group |
| | 6. Pre/post, control group |
| Study Design2 | |
| Randomized | 0. No |
| | 1. Yes |
| Study Design3 | |
| Placebo controlled | 0. No |
| | 1. Yes |
| Study Design4 | |
| Blinding | 0. None |
| | 1. Single blind |
| | 2. Double blind |
| Country study conducted | 1. [use country listing] |
| [list multiple countries] | 2. |
| | X. xx |
| Patient Characteristics | |
| Patient Type | 0. Normal |
| [type classification varies according to disease] | 1. Mild to moderate Alzheimer's Disease |
| | 2. Moderate to severe Alzheimer's |
| Patient Age1 | |
| Age at enrollment (mean ± SD) | xx ± yy |
| Patient Age2 | |
| Age at diagnosis (mean ± SD) | xx ± yy |
| Patient Gender1 | 0. Male |
| | 1. Female |
| | 3. Mixed |
| Patient Gender2 | % Female |
| Body Weight [lb/kg, mean ± SD] | xx ± yy |
| Height [in/cm, mean ± SD] | xx ± yy |
| Body Mass Index1 [kg/m2, mean ± SD] | xx ± yy |
| Body Mass Index2 | 1. Underweight |
| [according to BMI] | 2. Normal weight |
| | 3. Overweight |
| | 4. Obese |
| | 5. Extreme obese |
| Race/ethnicity [NIH classifications] | |
| Ethnicity | 1. Hispanic or Latino |
| | 2. Not Hispanic or Latino |
| Race | 1. American Indian or Alaska Native |
| | 2. Asian |
| | 3. Black or African American |
| | 4. Native Hawaiian or Other Pacific Islander |
| | 5. White |
| Education level | 1. Less than high school |
| | 2. High school graduate |
| | 3. Some college |
| | 4. College graduate |
| | 5. Post-graduate |
| Family income | 1. Below median |
| | 2. Above median |
| Co-morbidities | |
| Diabetes | 0. No |
| | 1. Yes |
| Cardiovascular diseases | 0. No |
| | 1. Yes |
| Other conditions | 0. No |
| | 1. Yes |
| Family history | 0. No |
| | 1. Yes |
| Time since disease diagnosis | xx ± yy |
| Treatment/Intervention [characteristics] | |
| Group | 0. Placebo/control |
| | 1. Treatment/intervention 1 |
| | 2. Treatment/intervention 2 |
| Treatment/Intervention [varies according to disease] | 0. Placebo |
| | 1. Citalopram |
| | 2. Donepezil |
| | 3. Donepezil + Memantine |
| | 4. Galantamine |
| | 5. Immunoglobulin (intravenous), 0.2 g/kg |
| | 6. Rivastigmine |
| | 7. Vitamin D |
| Dose type | 0. Fixed dose |
| | 1. Variable dose |
| Treatment/Intervention duration [days/weeks] | xxx |
| Treatment/Intervention compliance | xx % |
| Sample size | |
| Pre-treatment/intervention | xxx |
| Post-treatment/intervention | xxx |
| Treatment/Intervention Outcome Measures [varies | |
| according to disease] | |
| | 1. ADAS-cog (Alzheimer's Disease Assessment |
| | Scale-Cognitive Subscale) |
| | 2. ADCS-ADL23 (Alzheimer's Disease Cooperative |
| | Study Activities of Daily Living Inventory) |
| | 3. BADLS (Bristol Activities of Daily Living Scale) |
| | 4. CIBIC-plus (Clinician's Interview-Based |
| | Impression of Change Plus Caregiver Input) |
| | 5. DAD (Disability Assessment for Dementia) |
| | 6. DEMQOL-Proxy |
| | 7. HQ-12 (General Health Questionnaire 12) |
| | 8. MMSE (Mini-Mental State Examination) |
| | 9. NPI (Neuropsychiatric Inventory) |
| | 10. ROSA (Relevant Outcome Scale for |
| | Alzheimer's) |
| | 11. SIB (Severe Impairment Battery) |
| | 12. SMMSE (Standardized Mini-Mental State |
| | Examination) |
| Pre-treatment/intervention outcome | xx ± yy |
| [mean ± SD] | |
| Post-treatment/intervention outcome | xx ± yy |
| [mean ± SD] | |
| Pre-treatment/intervention outcome | xx.xx |
| [standardize effect size] | |
| Post-treatment/intervention outcome | xx.xx |
| [standardize effect size] | |
| Funding | 0. Self |
| | 1. Federal/government agency |
| | 2. Foundation [private] |
| | 3. Pharmaceutical |
| Funding [list] | xxx |

I claim:

1. A method of constructing a database of biomedical research information, the method comprising the steps of:
searching biomedical research information comprising a plurality of biomedical research studies;
identifying a biomedical research study of interest;
extracting variables of interest and values thereof from the identified biomedical research study;
standardizing the values of the extracted variables of interest; and
populating a computer-readable database with the standardized values of the extracted variables, thereby constructing the database of biomedical research information.

2. The method of claim 1, wherein the extracted variables comprise a plurality of variables for each identified biomedical research study.

3. The method of claim 2, wherein the plurality of variables comprise at least two of the following:
publication information;
country of origin;
citation source;
patient demographic information;
medical condition;
treatment parameter;
outcome parameter;
experimental design parameter;
subject inclusion and/or exclusion criteria;
sample size;
side effects;
study duration;
analytical methodology;
supervision parameter; or
protocol adherence methodology.

4. The method of claim 3, wherein the plurality of variables comprise:
at least one variable related to a study characteristic that may affect an outcome parameter; and
at least one variable that reflects the outcome parameter.

5. The method of claim 1, wherein the database of biomedical information is index-searchable by any one or more of the variables of interest.

6. The method of claim 1, wherein the standardizing step comprises reviewing the values of the extracted variables of interest against a taxonomy of coding procedure and modifying the values in accordance with the taxonomy of coding procedure to facilitate comparisons across any number of different biomedical research studies.

7. The method of claim 6, wherein the modifying the values comprises manual review and coding.

8. The method of claim 7, further comprising the step of validating the manual review and coding.

9. The method of any of claims 6-8, wherein the database further comprises:
coded variables for all relevant characteristics of each biomedical research study;
calculated standardized effect size or an outcome parameter; and
original metric outcome.

10. The method of claim 1, wherein the standardizing step further comprises:
providing a validated data extraction form; and
inputting the standardized extracted variables of interest to the validated data extraction form; wherein the validated data extraction form is configured for computer-implemented entry into the computer-readable database.

11. The method of claim 10, further comprising repeating the inputting step to identify input differences to minimize coding drift and increase reliability.

12. The method of claim 1, wherein the searched biomedical research information comprises published and unpublished studies.

13. The method of claim 1, wherein the searched biomedical research information comprises grey literature.

14. The method of claim 1, wherein the searched biomedical research information comprises a publicly-accessible database.

15. The method of claim 1, wherein the searched biomedical research information comprises a commercially-accessible database.

16. The method of claim 1, wherein the searched biomedical research information comprises substantially all peer-reviewed biomedical journals in a language that is English.

17. The method of claim 16, wherein the searched biomedical research information further comprises non-English language publications.

18. The method of claim 1, wherein the searched biomedical research information comprises data extracted from individual research studies of at least one of a medical disease treatment and associated outcome.

19. The method of claim 1, wherein the biomedical research studies are directed to treatment of a medical condition associated with the group consisting of:
neurological disease;
cardiovascular disease;
cancer;
endocrine or metabolic disease;
respiratory disease;
infectious disease;
pediatric disease;
reproductive disease;
gastrointestinal disease;
musculoskeletal or connective tissue disease;
renal or urological disease;
hematological disease;
psychiatric disease; and
dermatological disease.

20. The method of claim 1, wherein the searching comprises a software implemented internet search engine that continuously or periodically searches internet sources for available biomedical research studies.

21. The method of claim 1, wherein the searching is a systematic and thorough search of available biomedical research studies of a medical disease and associated outcome.

22. The method of claim 1, further comprising the step of updating the database by periodically repeating the searching to include any newly available biomedical research studies.

23. The method of claim 1, wherein the searching comprises:
identifying a specific investigator; and
requesting the specific investigator to:
provide an investigator-submitted biomedical research study for inclusion in the database of biomedical information; or
supply a missing variable of interest for the biomedical research study of interest.

24. The method of claim 1, further comprising the step of validating the database of biomedical research information.

25. The method of claim 1, wherein the database of biomedical information is accessed by a medical provider, a medical researcher, or a consumer.

26. The method of claim 1, wherein the database is used to assist in making a clinical decision.

27. The method of claim 25 or 26, further comprising the steps of:
extracting data from the database of biomedical information by providing a search criteria, thereby generating an output data; and
displaying the extracted data to assist with the clinical decision.

28. The method of any of claims 25-26, wherein the database is accessible as a cloud-based subscription service.

29. The method of claim 27, wherein the search criteria includes a quality index score query.

30. The method of claim 27, wherein the extracting data step comprises pooling data from a plurality of biomedical research studies.

31. The method of claim 30, wherein the pooled data comprises biomedical research studies directed to treatment of a medical condition.

32. The method of claim 1, wherein the database is used to perform a meta-analysis across a plurality of selected studies.

33. The method of claim 1, wherein the biomedical research information comprises clinical trial studies or non-clinical trial studies.

34. The method of claim 1, further comprising storing said database in a computer readable media.

35. The method of claim 1, further comprising displaying one or more of said standardized values.

36. The method of claim 1, further comprising: analyzing a plurality of said standardized values to calculate one or more analysis parameters characterizing said biomedical research study of interest and populating the database with the one or more analysis parameters.

37. The method of claim 1, further comprising repeating said steps so as to obtain extracted variables of interest for a plurality of biomedical research studies of interest.

38. The method of claim 37, further comprising comparing the standardized values corresponding to different biomedical research studies.

39. The method of claim 38, further comprising one or more calculating analysis parameters obtained by said comparing the standardized values corresponding to different biomedical research studies and populating the database with the one or more analysis parameters.

40. The method of claim 36, wherein said analysis parameters correspond to information for the diagnosis or treatment of a disease condition.

41. The method of claim 36 or 40, further comprising populating said database with said analysis parameters.

42. The method of claim 1 further comprising providing access to said database to one or more users.

43. The method of claim 42, further comprising receiving an input corresponding to a user query and generating an output received by the user comprising one or more of said standardized values or one or more one or more analysis parameters derived from said standardized values.

44. The method of claim 43, further comprising storing said standardized values or one or more one or more analysis parameters on a computer readable media of said one or more users.

45. The method of claim 43, further comprising displaying said standardized values or one or more one or more analysis parameters for said one or more users.

46. A method of using a database of biomedical research information, the method comprising the steps of:
searching biomedical research information comprising a plurality of biomedical research studies;
identifying a biomedical research study of interest;
extracting variables of interest and values thereof from the identified biomedical research study;
standardizing the values of the extracted variables of interest;
populating a computer-readable database with the standardized values of the extracted variables of interest to construct a database of biomedical research information;
providing a search criteria input to the database of biomedical research information; and
obtaining selected information from the database of biomedical research information based on the search criteria, wherein the selected information comprises one or more of the standardized values.

47. The method of claim 46, further comprising the step of displaying the selected information from the database of biomedical research.

48. The method of claim 47, wherein the displaying is by an algorithm that transforms the obtained selected information into a user-friendly display.

49. The method of claim 48, wherein the user-friendly display is selected from the group consisting of: a graphical representation; a table; a list; and a biomedical protocol.

50. The method of claim 46, wherein the obtaining step is iterative.

51. The method of claim 46, further comprising analyzing the obtained information, the analyzing step comprising filtering at least a portion of the obtained information.

52. The method of claim 51, wherein the filtering comprises a qualitative or a quantitative assessment of the obtained information.

53. The method of claim 46, wherein the filtering comprises a statistical analysis of the obtained information.

54. The method of claim 46, wherein the obtained data comprises a pooled set of information from a plurality of biomedical research studies.

55. The method of claim 54, wherein the pooled set of information is used in an application selected from the group consisting of:
identifying treatment options for a medical condition;
evaluating treatment options for a medical condition;
selecting a treatment regimen for a medical condition;
designing a biomedical research study;
diagnosing a disease or medical condition;
identifying a medical provider; and
a meta-analysis of multiple biomedical research studies.

56. The method of claim 46, further comprising repeating said steps so as to obtain extracted variables of interest for a plurality of biomedical research studies of interest.

57. The method of claim 56, further comprising comparing the standardized values corresponding to different biomedical research studies.

58. The method of claim 57, further comprising one or more calculating analysis parameters obtained by said comparing the standardized values corresponding to different biomedical research studies and populating the database with the one or more analysis parameters.

59. The method of claim 58, wherein said analysis parameters correspond to information for the diagnosis or treatment of a disease condition.

60. The method of claim 46, further comprising receiving an input corresponding to a user query and generating an output received by the user comprising one or more of said standardized values or one or more analysis parameters derived from said standardized values.

61. The method of claim 60, further comprising storing said standardized values or one or more analysis parameters on a computer readable media of said one or more users.

62. The method of claim 60, further comprising displaying said standardized values or one or more analysis parameters for said one or more users.

63. The method of claim 60, wherein said input comprises a query relating to diagnosis of a patient and said output comprises diagnostic information.

64. The method of claim 60, wherein said input comprises a query relating to treatment of a patient and said output comprises treatment information.

65. Any of the above methods, wherein the database is a relational database.

66. Any of the above methods, wherein the standardizing comprises a coding procedure for one or more of the variables and codes of Table 1.

67. The method of claim 8, wherein the validating step comprises:
assigning the biomedical research study of interest to at least two analysts;
displaying the variables of interest to each of the two analysts, wherein each of the analysts independently code the variables of interest;
comparing the coded variables of interest by each of the analysts;
passing coded variables of interest that are identified as an exact match between each of the analysts;
identifying as a mismatch those coded variables of interest whose values do not match;
assigning the biomedical research study of interest to a senior analyst to evaluate the mismatched coded variables of interest and provide an action parameter, wherein the action parameter is one of:
sending the biomedical research study of interest back to at least one of the analysts for re-coding;
selecting one of the coded variables of interest as a correct value; or
self-coding the variable of interest to identify a third coded value as a correct coded value.
